(19) United States
(12) Patent Application Publication
(10) Pub. No.: US 2004/0089491 A1
(43) Pub. Date: May 13, 2004

(54) Creep torque command interrupt for HEVs and EVs

(75) Inventor: David C. Reuter, Ann Arbor, MI (US)

Correspondence Address: VISTEON 29074, BRINKS HOFER GILSON & LIONE, P.O. BOX 10395, CHICAGO, IL, 60611, US

(73) Assignee: Visteon Global Technologies, Inc.

(21) Appl. No.: 10/289,961

(22) Filed: Nov. 7, 2002

(51) Int. Cl. B60R 25/00

(52) U.S. Cl. 180/287

(57) ABSTRACT

A safety monitoring system employs a method of preventing unwanted drive-off of the vehicle. The method includes determining whether the vehicle is requesting traction drive torque via the powertrain supervisory control. Further, it is determined whether the driver has left the vehicle. Finally, the monitoring system interrupts the request for traction drive torque and sends an override request for zero torque when the vehicle is requesting traction drive torque and the driver has left the vehicle. Several timers are utilized to determine when traction drive torque should be removed and when the vehicle should be shut down.

### FIELD OF THE INVENTION

The present invention relates generally to safety monitoring systems for electric or hybrid electric vehicles, and more particularly relates to a safety system preventing inadvertent vehicle drive-away.

### BACKGROUND OF THE INVENTION

Current electric vehicles (EVs) and hybrid electric vehicles (HEVs) utilize, at least in part, an electric motor for providing drive torque to the vehicle. One of the many benefits of these vehicles includes significantly reduced noise as compared to modern vehicles utilizing gasoline engines. In fact, EVs and HEVs produce such little noise that drivers may forget that the vehicle is operational when it is not moving. Unfortunately, drivers may have a tendency to exit the vehicle while it is still operational and in gear, which can result in the vehicle driving away unattended. Accordingly, there exists a need to provide a safety monitoring system to prevent inadvertent vehicle drive-away in EVs and HEVs.

### BRIEF SUMMARY OF THE INVENTION

The present invention provides a safety monitoring system employing a method of preventing unwanted drive-off of the vehicle. Generally, the vehicle includes a powertrain supervisory control (PSC) responsible for sending traction drive torque requests that ultimately result in the transmission of drive torque to the wheels of the vehicle. The method includes determining whether the vehicle is requesting traction drive torque via the powertrain supervisory control. Further, it is determined whether the driver has left the vehicle. Finally, the monitoring system interrupts the request for traction drive torque and sends an override request for zero torque when the vehicle is requesting traction drive torque and the driver has left the vehicle. The original request for traction drive torque is merely interrupted so that the original request remains, but the actual command send for traction torque is zeroed. Preferably, the step of determining whether the driver has left the vehicle includes detecting whether the driver is in the driver seat and whether the driver's door was opened. It is also preferable to set a shutdown timer when the request for traction drive torque has been interrupted. When the shutdown timer has expired, the vehicle is placed in a shutdown state that requires key initialization to start the vehicle.

### BRIEF DESCRIPTION OF THE DRAWINGS

The accompanying drawings incorporated in and forming a part of the specification illustrate several aspects of the present invention, and together with the description serve to explain the principles of the invention. In the drawings:

FIG. 1 is a schematic of a powertrain of a hybrid electric vehicle employing the safety monitoring system in accordance with the teachings of the present invention;

FIG. 2 is a schematic of the powertrain illustrated in FIG. 1 depicting an alternate operation of the powertrain; and

FIG. 3 is a logic flow chart depicting the safety monitoring system in its method for preventing unwanted drive off of a vehicle.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

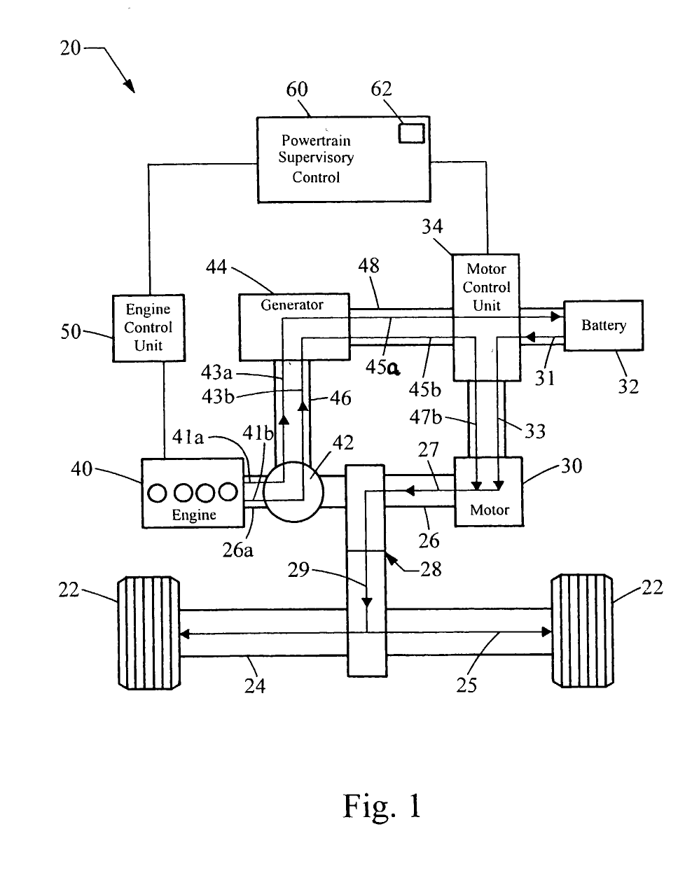

Turning now to the figures, FIG. 1 is a schematic depicting a powertrain 20 for a hybrid electric vehicle. The wheels 22 of the vehicle are generally connected by an axle 24 and are driven by a motor 30. The output of motor 30 drives a shaft 26, the rotation of which is transmitted to the axle 24 by way of a reduction gear 28. That is, the motor 30 generates a torque indicated by arrowed line 27 that is transmitted through the reduction gear 28 as indicated by arrowed line 29, which in turn is distributed to the wheels 22 by way of axle 24 as indicated by arrowed line 25.

The motor 30 is provided with electrical power by a battery 32, as indicated by arrowed lines 31 and 33. Distribution of electrical power from the battery 32 to the motor 30 is regulated by a motor control unit 34. The motor control unit typically includes various electronics such as the motor controller, the battery controller, the motor inverter, and a generator inverter. The motor control unit 34 may take many forms and house many various electronic devices, as will be appreciated by those skilled in the art.

The powertrain 20 also includes a gasoline engine 40. The output of engine 40 is routed through a power split device 42. FIG. 1 depicts the powertrain system 20 of the HEV being operated in a series mode, wherein the power split device 42 transmits the output energy from the gasoline engine 40 entirely to the generator 44. In turn, the generator 44 transmits electrical energy to the motor control unit 34. More specifically, a torque generated by gasoline engine 40 is transmitted to shaft 26a, as indicated by arrowed lines 41a and 41b. This torque is then transmitted through power split device 42 through a shaft 46 to a generator 44 as indicated by arrowed lines 43a and 43b. The generator 44 turns the kinetic energy from the shaft 46 into electrical energy which is transmitted through cable 48 to the motor control unit 34, as indicated by arrowed lines 45a and 45b. The motor control unit 34 will either direct the electricity to the battery 32 for storage, or will transmit the electricity to the motor 30 for driving the wheels 22. In sum, the energy generated by the gasoline engine 40 may be used to supply power to the battery 32, as indicated by arrowed lines 41a, 43a, and 45a, while the energy may also be used to power the motor 30, as indicated by arrowed lines 41 b, 43b, 45b and 47b.

As is known in the art, the gasoline engine 40 is operated by an engine control unit 50. In turn, the engine control unit 50 is operated by way of a powertrain supervisory control (PSC) 60. Likewise, the PSC 60 operates the motor control unit 34. Thus, as is known in the art, the PSC 60 is a high level controller for operating the vehicle powertrain 20. The PSC 60 performs various operations such as determining, generating and transmitting torque demands to the appropriate devices. The PSC 60 also receives various inputs including gear selection, selector position, battery information, cruise control inputs, and accelerator pedal inputs. Preferably, the PSC 60 communicates with the engine control unit 50 and the motor control unit 34 by way of the vehicle's CAN BUS communication protocol. It will also be recognized that various inputs could also be directly provided to either the motor control unit 34 or the engine control unit 50. In the present invention, the PSC 60 includes the safety monitoring system 62 for employing the method of the present invention.

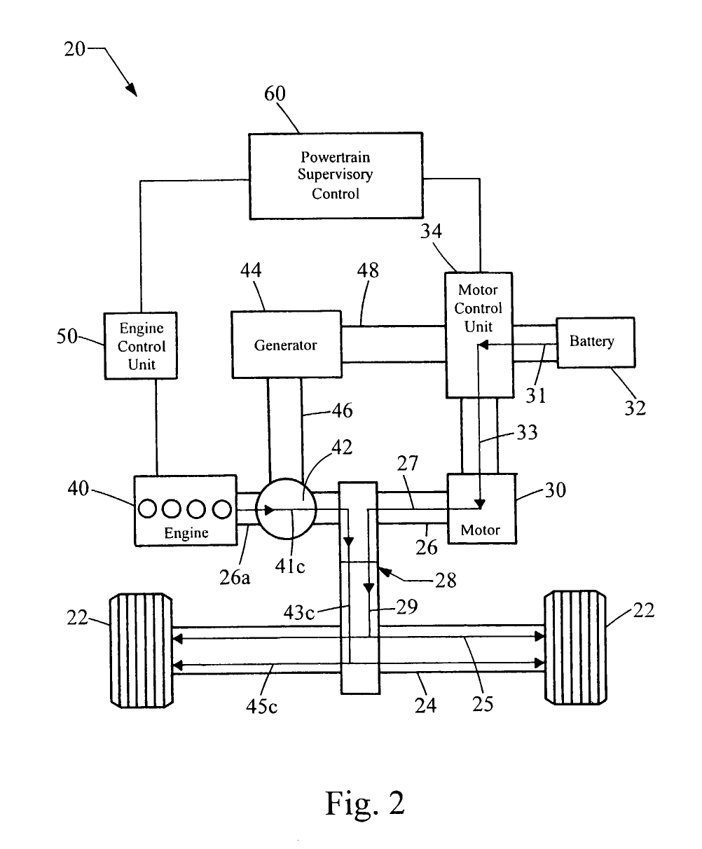

Turning now to FIG. 2, the powertrain system 20 is shown operating in a parallel mode. In this mode, the power split device 42 transmits the output energy from the gasoline engine 40 directly to the wheels 22. That is, the power split device 42 transmits rotational energy or torque from shaft portion 26a to the shaft 26, which in turn is transmitted through the reduction gear 28 to axle 24 and wheels 22. The power split device 42 transmits its torque through the shaft 26 as indicated by arrowed line 41c, which in turn is transmitted to the axle 24 and wheels 22 by way of reduction gear 28 as indicated by arrowed lines 43c and 45c.

As in the series mode, the battery 32 outputs electricity to the motor control unit 34 as indicated by arrowed line 31, and the motor control unit 34 transmits electrical energy to the motor 30 as indicated by arrowed line 33. Output energy from the motor 30 is transmitted through the shaft 26 as indicated by arrowed line 27, which in turn is transferred to the axle 24 by way of reduction gear 28 as indicated by arrowed line 29 and finally the wheels 22 as indicated by arrowed line 25.

The above description of the powertrain system 20 of one type of HEV has been provided for describing the safety monitoring system 62 and its method according to the present invention. Accordingly, it will be recognized by those skilled in the art that the present invention may be employed on any electric vehicle or hybrid electric vehicle which utilizes a controller for sending torque requests to a motor or engine. Furthermore, while the safety monitoring system 62 has been shown as employed within the powertrain supervisory control 60, it will be recognized that the monitoring system 62 may be employed in any of the powertrain's controllers or electronic units, especially as the CAN BUS facilitates communication between various electronic devices within the vehicle.

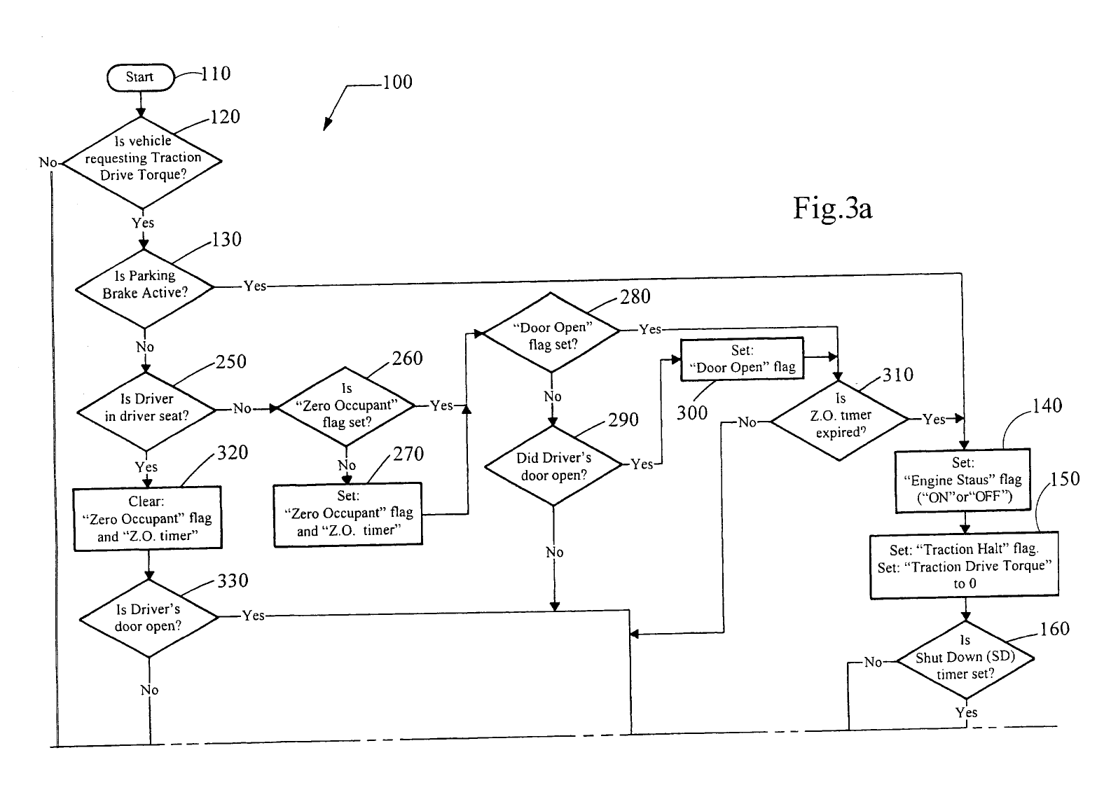

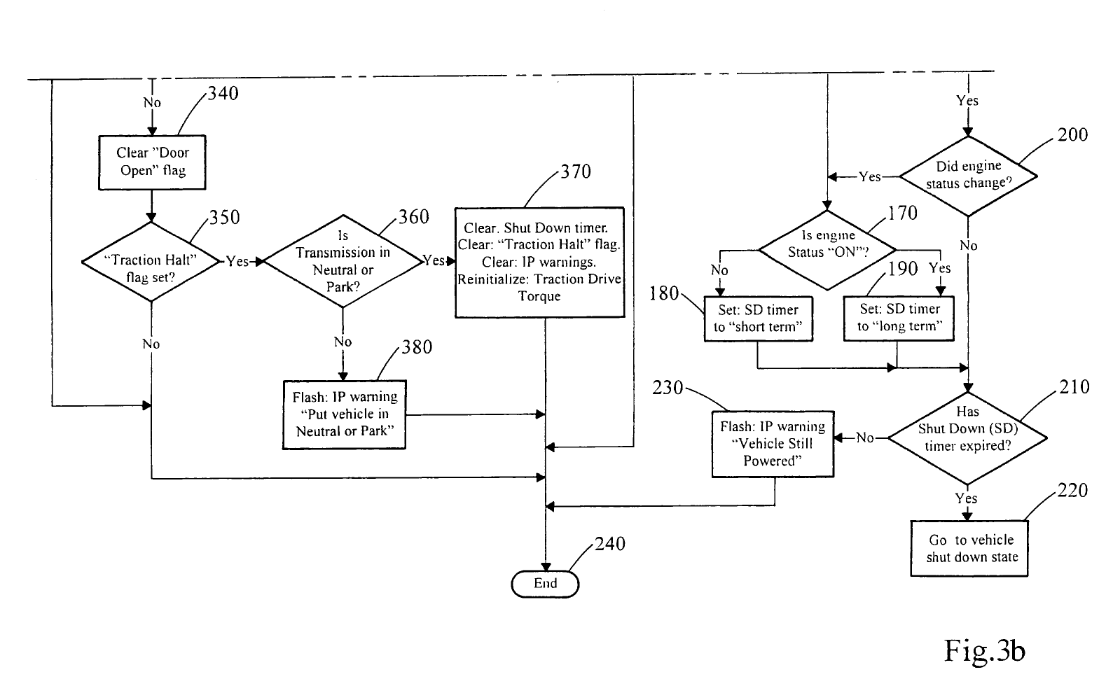

Turning now to FIG. 3, a method 100 is shown as a logic flow chart. The method 100 is utilized by the safety monitoring system 62 to prevent unwanted drive-off of the vehicle. The method starts as shown at block 110, and first determines whether the vehicle is requesting traction drive torque, as indicated by block 120. Traction drive torque, as used herein, refers to all torque requirements on the engine 40 or motor 30 (electric power train) for moving the wheels 22, as opposed to torque requirements to be applied elsewhere. That is, some torque requests are not for drive traction of the wheels 22, such as requests for running the engine to charge the battery or for running climate control. If, for example, the powertrain system of the particular vehicle allows the electric motor to disengage the powertrain via a clutch, the invention would allow the electric motor to run and act as a generator or a primary driver of say the AC compressor, if linked.

Typically, the PSC 60 issues a request for traction drive torque to either the engine control unit 50 or the motor control unit 34. For example, when the vehicle is in a forward gear, there is a small traction drive torque known as “creep torque” to prevent the vehicle from rolling backward. Again, traction drive torque is to be distinguished from other torque requests, such as when the PSC 60 sends a torque request to the engine 40 for supplying electricity to the battery 32 by way of the generator 44, as shown in FIG. 1 by arrowed lines 41a, 43a, and 45a.

As the invention is directed to preventing drive-off, the method immediately flows to its end, as indicated at block 240, when the vehicle is not requesting traction drive torque.

When the vehicle is requesting traction drive torque, the method determines if the parking brake is active, as indicated by block 130. If active, the method 100 flows to block 140 wherein an “engine status” flag is set as either ON or OFF. More specifically, if the engine is currently on, then the engine status flag is set to ON, and vice versa. Next, a “traction halt” flag is set, and the traction drive torque is set to zero, as indicated in block 150. More particularly, setting the traction drive torque to zero is an interrupt to a request. The original traction drive torque request still remains, but the actual command sent from the PSC 60 to either the engine control unit 50 or the motor control unit 34 is zeroed. That is, the original traction drive torque request is interrupted and an override request is sent that is equal to zero. Thus, despite any input from the acceleration pedal, or any other request for traction drive torque, the request command sent to one of the control units is zero, such that the wheels 22 are not torqued and the vehicle does not move.

Whenever the method flows to blocks 140 and 150, the traction drive torque request will be interrupted, and a shutdown timer will be set. The length of the shutdown timer is based on the current status of the engine. In either event, if the conditions remain and the shutdown timer has expired, the vehicle will enter a shutdown state that requires key initialization of the vehicle before traction drive torque requests will be sent, and the vehicle can be operated.

After interrupting the traction drive torque request, the method 100 decides whether the shutdown (SD) timer is set, as indicated at block 160. If the SD timer is not already set, it will be set based on the engine status. More particularly, the method flows to block 170 where it is determined whether the engine status flag is ON or OFF. If the engine status flag is ON, the method flows to block 190 where the SD timer is set to a “long term” value, which preferably is in the range of eight to twelve minutes. If the engine status is OFF, the method 100 flows to block 180 where the SD timer is set to a “short term” value, preferably in the range of one to three minutes. From either block 180 or block 190, the method 100 flows to block 210, where it is decided whether the SD timer has expired. When block 170 has been traversed, it is as a result of the SD timer not being sent, so the method 100 will flow to block 230 where an instrument panel warning is flashed, such as the warning “vehicle still powered.” At this point, the end of the method 100 is reached as indicated by block 240.

Returning to block 160, when the SD timer has been set, block 200 is reached. At this point, the method 100 decides whether the engine status has changed. If the answer is yes, the method 100 flows to block 170 and follows the aforementioned path. The yes answer would indicate the driver is merely entering or exiting the vehicle and turning the engine ON or OFF with the parking brake set. When the engine status has not changed, block 210 is reached where it is decided whether the SD timer has expired. If the SD timer has expired, the vehicle enters a shutdown state as indicated by block 220.

In the shutdown state, not only is the engine turned off, but the vehicle requires key initialization in order to turn the vehicle and the engine back on (i.e., the start-up process must be repeated.) The shutdown timer protects the vehicle from having drive torque in an event that a driver walked away from the vehicle still in gear, and another person such as a child that is in the vehicle and presses the acceleration pedal. In this case, the vehicle torque system is shut down and cannot restart until the gear selector is placed back into park and the vehicle go through the normal startup procedure such as pressing the brake, turn the key to crank, then selecting a drive gear.

When the shutdown timer has not expired, the instrument panel warning is flashed as indicated by block 230, and the method 100 reaches its end as indicated by block 240.

Returning now to block 130, when the parking brake is not active and the vehicle is requesting traction drive torque, the method 100 flows to block 250 where it is determined whether the driver is in the driver's seat. Generally, this determination can be made by standard seatbelt sensors, as is known in the art. Alternately, any of numerous sensors which have been specifically developed to determine whether a driver is in the seat can be employed, such as floor sensors, or position sensors built directly into the seat, or other light wave sensors such as infrared or laser sensors. When the driver is not in the driver's seat, the method 100 then determines whether or not the “zero occupant” flag has been set, as indicated at block 260. If the zero occupant flag has not been set, the method sets the zero occupant flag as well as the zero occupant (Z.O.) timer, as shown in block 270. Preferably, the Z.O. timer is set to a very short period of time such as two to ten seconds, to ensure that the driver has actually left the vehicle and is not merely shifting position in the driver's seat.

Once the zero occupant flag has been set, the method 100, from either blocks 260 or 270, next determines whether or not the “door open” flag has been set, as shown in block 280. If the door open flag has not been set, the method next determines whether or not the driver's door did open as indicated by block 290. As is noted in the art, standard sensors are employed in most vehicles for detecting whether or not a door, and more particularly the driver's door, is open or closed. It will be recognized that the determination as to whether the driver is in the driver's seat and to whether the driver's door has been opened could be replaced by a single determination where it is determined whether or not the driver has left the vehicle, which can be offered by such sensors as light sensors.

If the driver's door is not opened, the method flows to its end at block 240. When the driver's door has opened, the method sets a door open flag as indicated by block 300, and then determines whether or not the Z.O. timer has expired, as shown in block 310. If the Z.O. timer has not expired, the method 100 simply ends at block 240. If the Z.O. timer has expired, this indicates that the vehicle is requesting traction drive torque while the driver is not in the driver seat and the driver's door has opened. Thus, in this situation, the method flows to block 140 and block 150 where the traction drive torque is set to zero, so that no torque requests are sent to the engine or motor to prevent further movement of the vehicle. From block 150, the method 100 will follow one of the previously described paths to the end at block 240. Accordingly, the removal of traction drive torque after expiration of the Z.O. timer protects the vehicle from driving off due to the fact that the driver left the vehicle in gear and stepped out of the car.

Returning to block 250, when the driver is in the driver's seat, the method 100 next clears the zero occupant flag and the Z.O. timer as shown in block 320. Then, the method decides whether the driver's door is open as indicated by block 330. If the driver's door is open, the method 100 flows to its end at block 240. If the door is not open, this will indicate that the driver is in the driver's seat and the driver's door is closed, and the method 100 will proceed towards restarting the actual traction torque request. First, the door open flag will be cleared as shown by block 340. Next, the method will decide whether the traction halt flag has been set. If the traction halt flag has not been set, this indicates that the traction drive torque was never interrupted or overridden, and the method will flow to its end at block 240. If the traction halt flag is set, the method 100 will first determine that the transmission is in neutral or park before restarting the actual traction drive torque request. As shown in block 360, if the transmission is not in neutral or park, the method 100 will flash an instrument panel warning such as “put vehicle in neutral or park”, as shown in block 380, and then end at block 240. When the transmission is in neutral or park, the method 100 will clear the SD timer, clear the traction halt flag, clear the instrument panel warnings, and reinitialize, i.e., stop interrupting the traction drive torque request, at which point the method will end at block 240.

Now that the method 100 has been described, a few examples will be illustrative. If a driver is in the driver's seat with the door shut, the parking brake off, and the vehicle in gear, the method 100 will flow through blocks 110, 120, 130 to block 250 then 320, 330, 340, 350 to the end at 240. Thus, in this situation, the method 100 will not interrupt any traction drive torque requests or put the vehicle in a shutdown state.

In a situation where the vehicle is requesting traction drive torque and the parking brake is active, the traction drive torque requests will be interrupted to prevent damage to the vehicle. Further, the disabling of the traction drive torque until the parking brake has been removed prevents wasted energy from the battery. If the vehicle continues to request traction drive torque and the parking brake remains active, the vehicle will eventually enter a shutdown state when the SD timer has expired.

If the vehicle is requesting traction drive torque and the driver is not detected in the driver's seat, the method 100 will set a zero occupant timer which, when expired and when the driver's door was detected to be opened, the traction drive torque request will be interrupted and an override request for zero torque will be sent by the PSC 60. That is, the determination from block 120 will be yes, the determination from block 250 will be no and the determination from 290 will be yes, and when the Z.O. timer has expired, the determination from block 310 will be yes which results in the traction drive torque being interrupted and an override request for zero torque being sent.

Once the traction drive torque has been removed, if the driver has not re-entered the vehicle, sat in the driver's seat, and closed the door, the interrupt and override request will remain until the shutdown timer has expired, at which time the vehicle will enter a shutdown state.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A method of preventing unwanted drive-off in a vehicle having a powertrain supervisory control (PSC), the method comprising the steps of:
determining whether the vehicle is requesting traction drive torque via the powertrain supervisory control;
determining whether a driver has left the vehicle; and
interrupting the request for traction drive torque and sending an override request for zero torque if the vehicle is requesting traction drive torque and if the driver has left the vehicle.

2. The method of claim 1, wherein the step of determining whether the driver has left the vehicle includes the steps of:
determining whether driver is in the driver seat; and
determining whether the driver's door was opened.

3. The method of claim 1, further comprising the step of determining whether the parking brake is active.

4. The method of claim 3, wherein the step of interrupting the request for traction drive toque is executed if the parking brake is active and the vehicle is requesting traction drive torque.

5. The method of claim 1, further comprising the step of setting a shut down timer when the request for traction drive torque has been interrupted.

6. The method of claim 5, further comprising the step of placing the vehicle in a shut down state when the request for traction drive torque has been interrupted and the shut down timer has expired.

7. The method of claim 5, further comprising the step of determining whether the engine status is “on” or “off”, and wherein the shut down timer has a longer period when the engine status is “on” than when the engine status is off.

8. The method of claim 1, wherein the vehicle is an electronic vehicle having a motor for executing the traction torque request.

9. The method of claim 1, wherein the vehicle is a hybrid vehicle having a motor and an engine for executing the traction torque request.

10. The method of claim 1, further comprising the step of transmitting the request for traction drive torque when the driver is in the vehicle seat and the driver's door did not open.

11. The method of claim 10, further comprising the step of setting a traction halt flag when the override request for zero drive torque is sent, and wherein the step of transmitting the request for traction drive torque includes the step of determining whether the vehicle transmission is in Neutral or Park after the traction halt flag has been sent.

12. The method of claim 10, further comprising the step of setting a shut down timer when the request for traction drive torque has been interrupted, and wherein the step of transmitting the traction drive torque includes clearing the shut down timer and clearing the traction halt flag.

13. The method of claim 1, further comprising the step of sending an instrument panel warning that the vehicle is still powered when the traction drive torque request has been interrupted.

14. The method of claim 1, further comprising the step of setting a zero occupant timer when the driver is not detected in the driver's seat.

15. The method of claim 14, further comprising the step of Interrupting and sending override request only when the zero occupant timer has expired.
